(19) United States
(12) Patent Application Publication
(10) Pub. No.: US 2025/0350011 A1
(43) Pub. Date: Nov. 13, 2025

(54) RIGHT-ANGLE ELBOW ASSEMBLY, SIGNAL TRANSMITTER, AND SIGNAL RECEIVER

(71) Applicants: PROSE TECHNOLOGIES (SUZHOU) CO., LTD., Suzhou (CN); PROSE TECHNOLOGIES LLC, Mount Olive, NJ (US)

(72) Inventors: Lei WANG, Suzhou (CN); Xing ZHANG, Suzhou (CN)

(21) Appl. No.: 19/272,838

(22) Filed: Jul. 17, 2025

Related U.S. Application Data
(63) Continuation of application No. PCT/CN2023/080999, filed on Mar. 13, 2023.

(30) Foreign Application Priority Data
Jan. 18, 2023 (CN) 202310066200.6

(51) Int. Cl. H01P 1/02; H01Q 5/55

(52) U.S. Cl. CPC H01P 1/02; H01Q 5/55

(57) ABSTRACT

A right-angle elbow assembly includes: a first end portion and a second end portion; a connect portion extending between the first end portion and the second end portion; and a ridge portion positioned in the connect portion and above a transition surface of the connect portion.

### RELATED APPLICATION(S)

This application is a continuation application of PCT Patent Application No. PCT/CN2023/080999, filed on Mar. 13, 2023, which claims priority to Chinese Patent Application No. 202310066200.6 filed with the National Intellectual Property Administration, People's Republic of China on Jan. 18, 2023, all of which are incorporated herein by reference in entirety.

### FIELD OF THE TECHNOLOGY

The present disclosure relates to a field of communication, and more particularly to a right-angle elbow assembly, a signal transmitter, and a signal receiver.

### BACKGROUND

Waveguide is a structure used to guide electromagnetic waves in a direction. In electromagnetism and communication engineering, a waveguide may refer to any linear structure that transmits electromagnetic waves between its ends, and as commonly known is a hollow metal tube used to transmit radio waves.

Waveguides are primarily used as transmission lines at microwave frequencies and are used in microwave ovens, radar, communication satellites, and microwave radio link equipment to connect microwave transmitters and receivers to their antennas.

Common waveguide structures mainly include parallel twin wires, coaxial lines, parallel slab waveguides, rectangular waveguides, circular waveguides, microstrip lines, slab dielectric optical waveguides, and optical fibers. From the perspective of guiding electromagnetic waves, the waveguide may be divided into an inner area and an outer area, and the electromagnetic wave is restricted to propagate in the inner area (where the principle of transverse resonance in the cross section of the waveguide is met).

FIG. 1 shows a schematic diagram of a right-angle elbow assembly 100 in certain existing technologies, and FIG. 2 shows a schematic diagram of another right-angle elbow assembly 200 in certain other existing technologies. However, both the right-angle elbow assemblies 100 and 200 in FIG. 1 and FIG. 2 may only realize the single-polarization right-angle bend of the TE10 mode. Among them, the arrows in FIG. 1 and FIG. 2 represent direction of the TE10 mode electric field.

### SUMMARY

Awareness is made in view of problems in certain existing technology, where conduction of the electric field direction is limited only on the opposite short side, that is, only the monopole right-angle turn of the TE10 mode may be realized. The present disclosure in certain embodiment(s) provides a dual-polarized right-angle elbow assembly of the TE11 (transverse electric 11) mode, where a ridge portion is configured inside of the right-angle elbow assembly to provide a dual-polarized right-angle elbow assembly of the TE11 mode. In some embodiments, the 11 in TE11 refers to first-order angular mode and first-order radial mode.

The present disclosure in a first aspect provides a right-angle elbow assembly for a square waveguide, the right-angle elbow assembly including: a first end portion and a second end portion; a connect portion extending between the first end portion and the second end portion; and a ridge portion positioned in the connect portion and above a transition surface of the connect portion.

The right-angle elbow assembly for a square waveguide according to certain embodiment(s) of the present disclosure has a ridge portion on the transition surface, thereby enabling conduction in the direction of the electric field in two mutually orthogonal polarization directions, such that the right-angle elbow assembly for square waveguides according to certain embodiment(s) of the present disclosure delivers enhanced electrical performance.

In certain embodiment(s), the transition surface connects an outer surface of the first end portion and an outer surface of the second end portion.

In certain embodiment(s), a cross section of the first end portion is a square and a cross section of the second end portion is a square. Those skilled in the art understand that the cross section of the first end portion may also be in the shape of a rectangle resembling a square and the cross section of the second end portion may also be in the shape of a rectangle resembling a square.

In certain embodiment(s), the first end portion contacts the second end portion. In certain embodiment(s), the first end portion and the second end portion are not parallel to each other, but are connected via the connect portion.

In certain embodiment(s), the ridge portion is perpendicular to the transition surface of the connect portion. In this way, the signal transmission performance of the right-angle elbow assembly according to certain embodiment(s) of the present disclosure may be further improved.

In certain embodiment(s), the transition surface is configured as a chamfered surface of an outside corner of the right-angle elbow assembly. In certain embodiment(s), the chamfered surface is symmetrical about a first plane that respectively forms an angle of 45 degrees with an inner surface of the first end portion and with an inner surface of the second end portion.

In certain embodiment(s), the ridge portion includes at least one ridge sub-portion, and the cross section of the ridge sub-portion perpendicular to the chamfer surface is configured as a triangle. In certain embodiment(s), in an embodiment according to the present disclosure, the number of the at least one ridge sub-portion is configured as one, two or three.

In certain embodiment(s), the ridge portion is symmetrical about the first plane.

In certain embodiment(s), the transition surface is configured as a stepped surface connecting the outer surface of the first end portion and the outer surface of the second end portion. In certain embodiment(s), the stepped surface includes at least two steps.

In certain embodiment(s), the ridge portion includes at least one ridge sub-portion, and the number of the steps included in the stepped surface is one less than the number of the sub-ridges.

In certain embodiment(s), a length of the ridge sub-portion is no greater than a length of the steps and a width of the ridge sub-portion is no greater than a width of the steps.

In certain embodiment(s), a thickness of the ridge sub-portion is no greater than 2% of a side length of the first end portion. In certain embodiment(s), the thickness of the ridge sub-portion is no greater than 1/80 of a side length of the first end portion.

In certain embodiment(s), the right-angle elbow assembly is configured as a TE11 mode right-angle elbow assembly.

In certain embodiment(s), the right-angle elbow assembly is configured as a hollow structure.

In certain embodiment(s), a longitudinal axis of the first end portion is perpendicular to a longitudinal axis of the second end portion.

The present disclosure in a second aspect provides a signal transmitter, the signal transmitter including an antenna and a right-angle elbow assembly described in relation to the first aspect of the present disclosure and coupled to the antenna.

The present disclosure in a third aspect provides a signal receiver, the signal receiver including an antenna and a right-angle elbow assembly described in relation to the first aspect of the present disclosure and coupled to the antenna.

In certain embodiment(s), the right-angle elbow assembly for a square waveguide has a ridge portion positioned on the transition surface, thereby enabling conduction in the electric field in two mutually orthogonal polarization directions, such that the right-angle elbow assembly for square waveguides according to certain embodiment(s) of the present disclosure are with enhanced electrical performance in comparison to certain existing designs.

### BRIEF DESCRIPTION OF THE DRAWINGS

Embodiments are shown and explained with reference to the drawings. The drawings serve to clarify certain principles and show aspects which are helpful for understanding certain principles. The drawings are not necessarily to scale. In the drawings, the same reference numerals indicate similar features.

FIG. 1 shows a schematic diagram of a right-angle elbow assembly 100 in certain existing technologies;

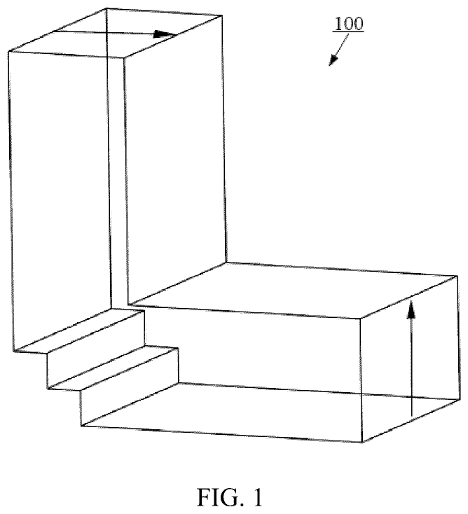

FIG. 2 shows a schematic diagram of a right-angle elbow assembly 100 in certain existing technologies;

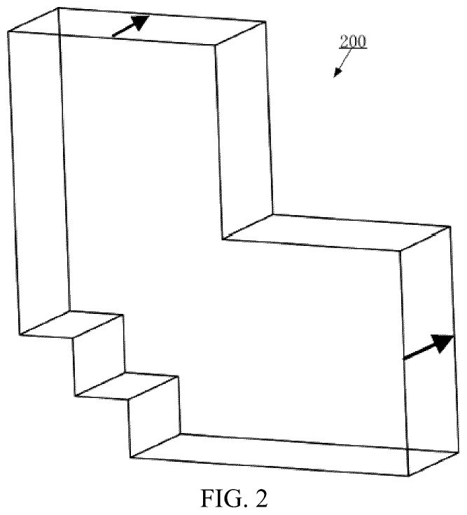

FIG. 3A shows a schematic diagram of a right-angle elbow assembly 300A for a square waveguide according to certain embodiment(s) of the present disclosure;

FIG. 3B shows a schematic diagram of a right-angle elbow assembly 300B for a square waveguide according to certain embodiment(s) of the present disclosure;

FIG. 3C shows a schematic diagram of a right-angle elbow assembly 300C for a square waveguide according to certain embodiment(s) of the present disclosure;

FIG. 4 shows a schematic diagram of a right-angle elbow assembly 400 for a square waveguide according to certain embodiment(s) of the present disclosure;

FIG. 5 shows a schematic diagram of a right-angle elbow assembly 500 for a square waveguide according to certain embodiment(s) of the present disclosure; and

FIG. 6 shows an internal structure diagram of the right-angle elbow assembly 500 for the square waveguide in FIG. 5.

Other features, characteristics, advantages and benefits of the present disclosure will become more apparent from the following detailed description in conjunction with the accompanying drawings.

### DETAILED DESCRIPTION

Regarding the embodiments described herein, reference is made to the accompanying drawings which form a part of the present disclosure. The accompanying drawings show, by way of example, embodiments in which the disclosure may be practiced. The illustrated embodiments are not intended to be exhaustive of all embodiments according to the present disclosure. Other embodiments may be utilized, and structural or logical changes may be made without having to depart from the scope of the present disclosure. The following detailed description is not limiting, and the scope of the present disclosure is defined by the appended claims.

Like reference numerals refer to like elements throughout the drawings. In the drawings, dimensions of some features may have been altered for clarity.

The terminology used in the preset disclosure is for describing certain embodiments only, and is not intended to limit the present disclosure. Unless otherwise defined, all terms (including technical terms and scientific terms) used in the present disclosure have meanings commonly understood by those skilled in the art. Well-known functions or constructions may not be described in detail for brevity and/or clarity.

The singular forms “a” and “the” used in the present disclosure include plural forms unless clearly stated otherwise. The terms “comprise” and “include” are used in the present disclosure to indicate the presence of claimed feature but not to exclude the presence of one or more other features. The term “and/or” used in the present disclosure includes any and all combinations of one or more of the related listed items. The terms “between X and Y” and “between about X and Y” used in the present disclosure should be construed to include X and Y. As used in the present disclosure, the term “between about X and Y” means “between about X and about Y”, and the term “from about X to Y” is used to mean “from about X to about Y”.

In the present disclosure, when an element is referred to as being “on”, “attached to,” “connected to”, “coupled to”, or “in contact with” another element, the element may be directly on, attached to, connected to, coupled to, or contact another element, or intervening element(s) may be present. In contrast, saying that an element is “directly on” another element, “directly attached to” another element, “directly connected to” another element, “directly coupled” to another element, “directly touching” another element, there will be no intervening element(s). In the present disclosure, a feature arranged “adjacent” to another feature may mean that a feature has a portion that overlaps an adjacent feature or that is located above or below an adjacent feature.

In the present disclosure, terms of spatial relation such as “upper”, “lower”, “left”, “right”, “front”, “rear”, “higher”, “lower”, or the like may describe the relationship between one feature and another in the attached drawings. The spatially relative terms encompass different orientations of the device in use or operation, in addition to the orientation depicted in the drawings. For example, if the device in the drawings is turned over, features described as “below” other features would then be oriented “above” the other features. The device may be otherwise oriented (rotated 90 degrees or at other orientations) and the relative spatial relationships are interpreted accordingly.

As mentioned herein, awareness is made in view of problems in certain existing technology, where conduction of the electric field direction is limited only on the opposite short side, that is, only the monopole right-angle turn of the TE10 mode may be realized. The present disclosure in certain embodiment(s) provides a dual-polarized right-angle elbow assembly of the TE11 mode, where a ridge portion is configured inside of the right-angle elbow assembly.

The present disclosure in certain embodiment(s) provides a right-angle elbow assembly for a square waveguide, the right-angle elbow assembly including: a first end portion and a second end portion; a connect portion extending between the first end portion and the second end portion; and a ridge portion positioned inside of the connect portion and positioned above a transition surface of the connect portion.

According to certain embodiment(s) of the present disclosure, the right-angle elbow assembly for a square waveguide has a ridge portion on the transition surface, thereby enabling conduction in the direction of the electric field in two mutually orthogonal polarization directions, such that the right-angle elbow assembly for square waveguides according to certain embodiment(s) of the present disclosure are with enhanced electrical performance in comparison to certain existing designs.

In certain embodiment(s), the transition surface connects the outer surface of the first end portion and the outer surface of the second end portion.

In certain embodiment(s), the cross section of the first end portion is square and the cross section of the second end portion is square. In certain embodiment(s), the cross section of the first end portion is in the shape of a rectangle resembling a square and the cross section of the second end portion is in the shape of a rectangle resembling a square.

In certain embodiment(s), the first end portion contacts or intersects the second end portion. In certain embodiment(s), the first end portion and the second end portion are not parallel to each other, but are connected via the connect portion. In certain embodiment(s), the longitudinal axis of the first end portion and the longitudinal axis of the second end portion are perpendicular to each other. In certain embodiment(s), an extension of the first end portion intersects an extension of the second end perpendicularly.

In certain embodiment(s), the ridge portion is perpendicular to the transition surface of the connect portion. In this way, the signal transmission performance of the right-angle elbow assembly according to the present disclosure may be further improved.

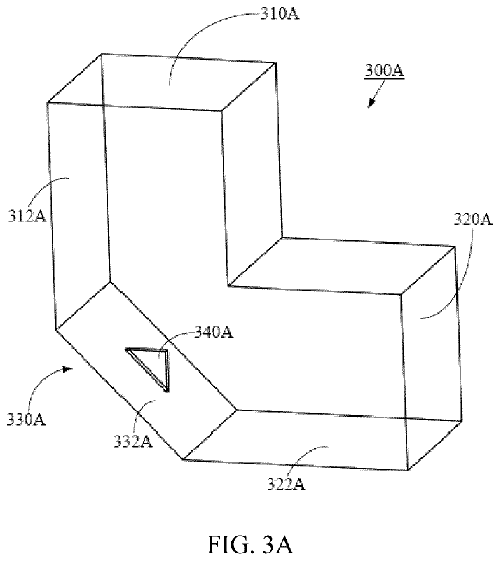

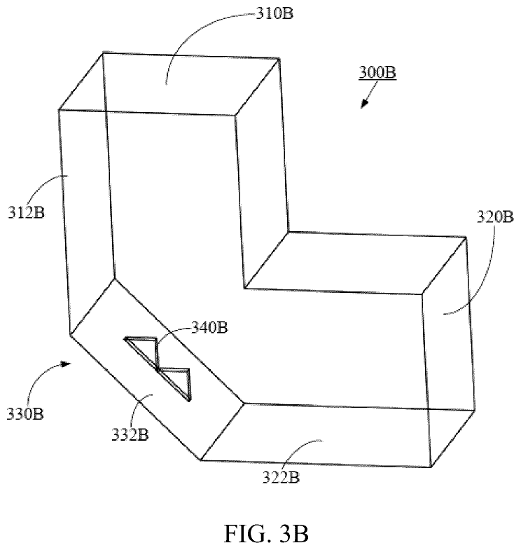

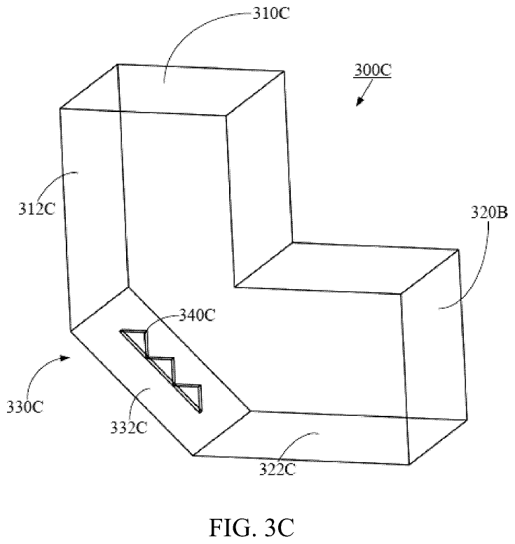

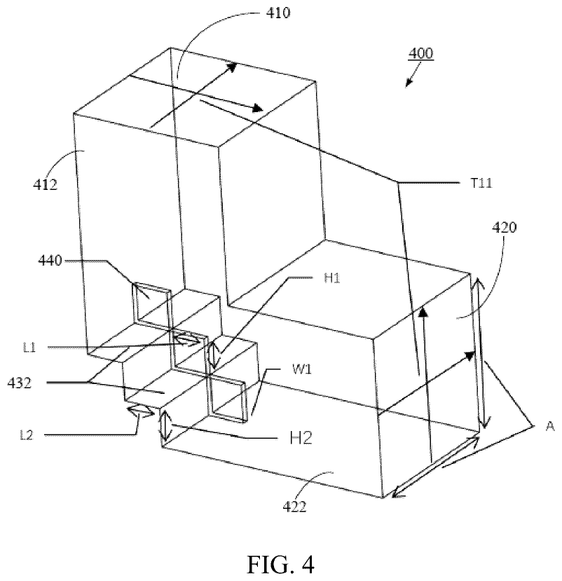

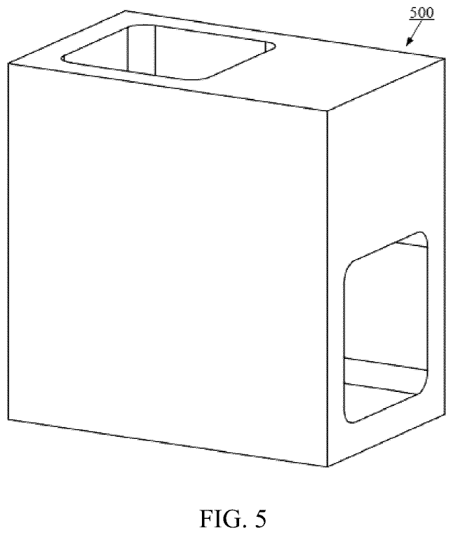

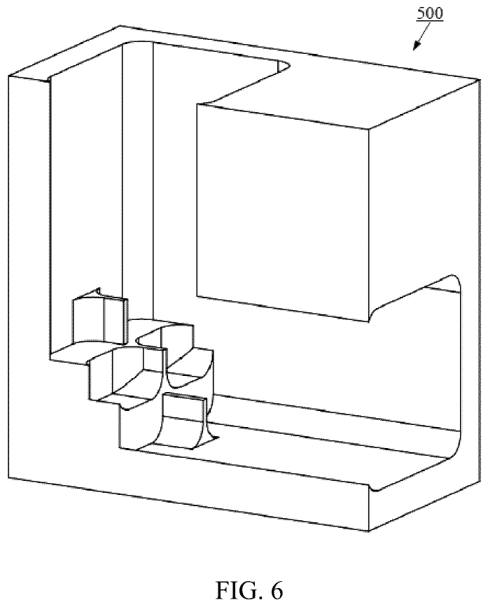

In certain embodiment(s), FIG. 3A, FIG. 3B, FIG. 3C, FIG. 4, FIG. 5, and FIG. 6 illustrate the right-angle elbow assembly for square waveguide according to the present disclosure. In certain embodiment(s), FIG. 3A, FIG. 3B, and FIG. 3C show that the right-angle elbow assemblies 300A, 300B, and 300C for square waveguides are relatively similar, and differ in that the number of ridge sub-portions varies. In certain embodiment(s), the right-angle elbow assembly 300A for a square waveguide in FIG. 3A includes only one ridge sub-portion, and the right-angle elbow assembly 300B for a square waveguide in FIG. 3B includes only two ridge sub-portions. In certain embodiment(s), the right-angle elbow assembly 300C for a square waveguide in FIG. 3C includes three ridge sub-portions.

Here, in order to illustrate the structure of the ridge portion in the cavity surrounded by the connect portion, FIG. 3A, FIG. 3B, FIG. 3C, FIG. 4, and FIG. 6 are all cut-away perspective views, which are perspective view after a front is cut away from the right-angle elbow assemblies 300A, 300B, 300C, 400 and 500 used for square waveguides.

The right-angle elbow assemblies 300A, 300B, and 300C for square waveguides shown in FIGS. 3A, 3B, and 3C each have a partially shared structure.

The right-angle elbow assembly 300A for a square waveguide shown in FIG. 3A includes two end portions, a first end portion 310A and a second end portion 320A. A cross section of the first end portion 310A is a square (in the drawing illustration shown in FIG. 3A it looks like a rectangle due to the angle, but the actual object is square) and a cross section of the second end portion 320A is also a square (in the drawing illustration shown in FIG. 3B it looks like a rectangle due to the angle but the actual object is a square). In certain embodiment(s), the right-angle elbow assembly 300A for a square waveguide shown in FIG. 3A further includes a connect portion 330A, and the connect portion 330A extends between the first end portion 310A and the second end portion 320A. In certain embodiment(s), the right-angle elbow assembly 300A for a square waveguide shown in FIG. 3A also includes a ridge portion 340A disposed in the connect portion 330A and perpendicular to a transition surface 332A of the right-angle elbow assembly. In certain embodiment(s), to realize an arrangement of the ridge portion 340A being in the connect portion 330A, the ridge portion 340A is positioned or attached inside the cavity formed by the connect portion 330A. In certain embodiment(s), to realize an arrangement of the ridge portion 340A being in the connection portion 330A, an inner surface of the ridge portion 340A is integral to an inner surface of the connect portion 330A, such that the ridge portion 340A is inside of a cavity formed via an integral molding. In certain embodiment(s), the transition surface 332A connects the outer surface 312A of the first end portion 310A and the outer surface 322A of the second end portion 320A. In certain embodiment(s), and as shown in FIG. 3A, the transition surface 332A is configured as a chamfer surface of an outside corner of the right-angle elbow assembly 300A. In certain embodiment(s), a first plane passes through a junction between an inner surface of the first end portion 310A and an inner surface of the second end portion 320A, and is respectively at a 45-degree to the inner surface of the first end portion 310A and to the inner surface of the second end portion, and the chamfer surface is symmetrical to the first plane. In certain embodiment(s), the ridge portion 340A is also symmetrical to the first plane.

In certain embodiment(s), and as shown in FIG. 3A, the ridge portion 340A includes a ridge sub-portion, and a cross section of the ridge sub-portion perpendicular to the chamfer surface 332A is configured, for example, as a triangle. In certain embodiment(s), and as shown in FIG. 3A, a number of the ridge sub-portion is configured as one.

The right-angle elbow assembly 300B for a square waveguide shown in FIG. 3B includes two end portions, namely a first end portion 310B and a second end portion 320B, a cross section of the first end portion 310B is a square (in the drawing illustration shown in FIG. 3B it appears to be a rectangle due to the angle, but the actual object is a square), and a cross section of the second end portion 320B is also a square (in the drawing illustration shown in FIG. 3B it appears to be a rectangle due to the angle, but the actual object is a square). In certain embodiment(s), the right-angle elbow assembly 300B for a square waveguide shown in FIG. 3B further includes a connect portion 330B, and the connect portion 330B extends between the first end portion 310B and the second end portion 320B. In certain embodiment(s), the right-angle elbow assembly 300B for a square waveguide shown in FIG. 3B also includes a ridge portion 340B disposed in the connect portion 330B and perpendicular to a transition surface 332B of the right-angle elbow assembly. In certain embodiment(s), to realize an arrangement of the ridge 340B being in the connect portion 330B, the ridge portion 340B is positioned or attached inside the cavity formed by the connect portion 330B. In certain embodiment(s), to realize an arrange of the ridge portion 340B being in the connect portion 330B, an inner surface of the ridge portion 340B is integral to an inner surface of the connect portion 330B, such that the ridge portion 340B is inside of a cavity formed via an integral molding. The transition surface 332B connects an outer surface 312B of the first end portion 310B and an outer surface 322B of the second end portion 320B. In certain embodiment(s), and as shown in FIG. 3B, the transition surface 332B is configured as a chamfer surface of an outside corner of the right-angle elbow assembly 300B. In certain embodiment(s), a first plane passes through a junction between an inner surface of the first end portion 310B and an inner surface of the second end portion 320B, and is respectively at a 45-degree to the inner surface of the first end portion 310B and to the inner surface of the second end portion 320B, and the chamfer surface is symmetrical to the first plane. In certain embodiment(s), the first plane is also symmetrical to the ridge portion 340B.

In certain embodiment(s), and as shown in FIG. 3B, the ridge portion 340B includes a ridge sub-portion, and a cross section of the ridge sub-portion perpendicular to the chamfer surface 332B is configured, for example, as a triangle. In certain embodiment(s), and shown in FIG. 3B, a number of the ridge sub-portions is configured as two.

A right-angle elbow assembly 300C for a square waveguide shown in FIG. 3C includes two end portions, a first end portion 310C and a second end portion 320C, a cross section of the first end portion 310C is a square (in the drawing illustration shown in FIG. 3C it appears to be a rectangle due to the angle, but the actual object is a square), and a cross section of the second end portion 320C is also a square (in the drawing illustration shown in FIG. 3C it appears to be a rectangle due to the angle, but the actual object is a square). In certain embodiment(s), the right-angle elbow assembly 300C for a square waveguide shown in FIG. 3C further includes a connect portion 330C, and the connect portion 330C extends between the first end portion 310C and the second end portion 320C. In certain embodiment(s), the right-angle elbow assembly 300C for a square waveguide shown in FIG. 3C also includes a ridge portion 340C disposed in the connect portion 330C and perpendicular to a transition surface 332C of the right-angle elbow assembly. In certain embodiment(s), to realize an arrangement of the ridge portion 340C being in the connect portion 330C, the ridge portion 340C is positioned or attached inside the cavity formed by the connect portion 330C. In certain embodiment(s), to realize an arrangement of the ridge portion 340C being in the connection portion 330C, an inner surface of the ridge portion 340C is integral to an inner surface of the connect portion 330C, such that the ridge portion 340C is inside of a cavity formed via an integral molding. In certain embodiment(s), the transition surface 332C connects the outer surface 312C of the first end portion 310C and the outer surface 322C of the second end portion 320C. In certain embodiment(s), and as shown in FIG. 3C, the transition surface 332C is configured as a chamfer surface of an outside corner of the right-angle elbow assembly 300C. In certain embodiment(s), a first plane passes through a junction between an inner surface of the first end portion 310C and an inner surface of the second end portion 320C, and is respectively at a 45-degree to the inner surface of the first end portion 310C and to the inner surface of the second end portion, and the chamfer surface is symmetrical to the first plane. In certain embodiment(s), the ridge portion 340C is also symmetrical to the first plane.

In certain embodiment(s), and as shown in FIG. 3C, the ridge portion 340C includes a ridge sub-portion, and a cross section of the ridge sub-portion perpendicular to the chamfer surface 332C is configured, for example, as a triangle. In certain embodiment(s), and as shown in FIG. 3A, a number of the ridge sub-portions is configured as three.

In addition to the herein-mentioned configuration of the chamfer surface, the transition surface may also be formed in other ways. FIG. 4 shows a schematic diagram of a right-angle elbow assembly 400 for a square waveguide according to certain embodiment(s). As may be seen from FIG. 4, and in certain embodiment(s), the transition surface is configured as a stepped surface 432 connecting the outer surface 412 of the first end portion 410 and the outer surface 422 of the second end portion 420. In certain embodiment(s), and as shown in FIG. 4, the stepped surface 432 includes two steps. In certain embodiment(s), the stepped surface 432 includes more steps, such as three steps or four steps, or more steps. In certain embodiment(s), there is a ridge sub-portion on the step. In certain embodiment(s), the ridge portion 440 includes at least one ridge sub-portion, for example, there are three ridge sub-portions as shown in FIG. 4. In certain embodiment(s), the number of steps included in the stepped surface 432 (for example there are two steps shown in FIG. 4) is one less than the number of ridge sub-portions (for example, there are three ridge sub-portions shown in FIG. 4). In terms of size, in certain embodiment(s) a length L1 of each ridge sub-portion in the ridge sub-portion 440 is not greater than a length L2 of each step, and/or a width H1 of the ridge sub-portion is not greater than a width H2 of the step. In certain embodiment(s), a thickness W1 of the ridge sub-portion does not exceed 2% (two percent) of a side length A of the first end portion. In certain embodiment(s), the thickness W1 of the ridge sub-portion does not exceed 1/80 (one of 80 equal parts) of the side length A of the first end portion. In certain embodiment(s), the right-angle elbow assembly 400 is configured as a TE11 mold right-angle elbow assembly. In certain embodiment(s), the right-angle elbow assembly 400 is configured as a hollow structure.

In certain embodiment(s), the right-angle elbow assembly 400 for the square waveguide shown in FIG. 4 may be formed by a digital control machine tool for processing. In certain embodiment(s), the first end portion and the second end portion have rounded corners, and the ridge portions and the like also have rounded corners. After processing by digital control machine tool, the right-angle elbow assembly 500 for square waveguide is shown in FIG. 5 in certain embodiment(s). FIG. 6 shows an internal structure diagram of the right-angle elbow assembly 500 for a square waveguide in FIG. 5. In certain embodiment(s), FIG. 6 shows an internal structure diagram of the right-angle elbow assembly 500 for square waveguide shown in FIG. 5.

In another aspect, the present disclosure provides a signal transmitter, which includes the right-angle elbow assembly 300A, 300B, 300C, 400, or 500 described herein.

In yet another aspect, the present disclosure provides a signal receiver, which includes the right-angle elbow assembly 300A, 300B, 300C, 400, or 500 described herein.

In certain embodiment(s), the right-angle elbow assembly for a square waveguide has a ridge portion positioned on the transition surface, thereby enabling conduction in the electric field in two mutually orthogonal polarization directions, such that the right-angle elbow assembly for square waveguides according to certain embodiment(s) of the present disclosure are with enhanced electrical performance in comparison to certain existing designs.

While various embodiments of the present disclosure have been described, it would be obvious to those skilled in the art that various changes and modifications may be made, one or some of the advantages of the present disclosure may be realized without having to depart from the spirit and scope of the present disclosure. Other components performing the same function may be appropriately substituted for those skilled in the art. Features explained herein with reference to a particular figure may be combined with features of other figures, even in those scenarios where such is not explicitly mentioned. Furthermore, the methods of the present disclosure may be implemented either in all software implementations using appropriate processor instructions or in hybrid implementations utilizing a combination of hardware logic and software logic to achieve the same results. Such modifications to the arrangements according to the present disclosure are intended to be covered by the appended claims.

What is claimed is:

1. A right-angle elbow assembly for a square waveguide, comprising:
a first end portion and a second end portion;
a connect portion extending between the first end portion and the second end portion; and
a ridge portion positioned in the connect portion and above a transition surface of the connect portion.

2. The right-angle elbow assembly according to claim 1, wherein the transition surface connects an outer surface of the first end portion and an outer surface of the second end portion.

3. The right-angle elbow assembly according to claim 1, wherein a cross section of the first end portion is a square and a cross section of the second end portion is a square.

4. The right-angle elbow assembly according to claim 1, wherein the first end portion contacts the second end portion.

5. The right-angle elbow assembly according to claim 1, wherein the ridge portion is perpendicular to the transition surface of the connect portion.

6. The right-angle elbow assembly according to claim 1, wherein the transition surface is configured as a chamfer surface of an outer corner of the right-angle elbow assembly.

7. The right-angle elbow assembly according to claim 6, wherein the chamfer surface is symmetrical to a first plane, and the first plane is of 45 degrees in angle to an inner surface of the first end portion and of 45 degrees in angle to an inner surface of the second end portion, respectively.

8. The right-angle elbow assembly according to claim 6, wherein the ridge portion comprises at least one ridge sub-portion, and a cross section of the at least one ridge sub-portion perpendicular to the chamfer surface is configured as a triangle.

9. The right-angle elbow assembly according to claim 8, wherein a number of the at least one ridge sub-portion is configured as one, two, or three.

10. The right-angle elbow assembly according to claim 7, wherein the ridge portion is symmetrical to the first plane.

11. The right-angle elbow assembly according to claim 1, wherein the transition surface is configured as a stepped surface connecting the outer surface of the first end portion and the outer surface of the second end portion.

12. The right-angle elbow assembly according to claim 11, wherein the stepped surface comprises at least two steps.

13. The right-angle elbow assembly according to claim 11, wherein the ridge portion comprises at least one ridge sub-portion, and a number of steps included in the stepped surface is one fewer than a number of the at least one ridge sub-portion.

14. The right-angle elbow assembly according to claim 13, wherein a length of the ridge sub-portion is no greater than a length of the steps and a width of the ridge sub-portion is no greater than a width of the steps.

15. The right-angle elbow assembly according to claim 1, wherein a thickness of the ridge sub-portion is no greater than 2% of a side length of the first end portion.

16. The right-angle elbow assembly according to claim 1, wherein a thickness of the ridge sub-portion is no greater than 1/80 of a side length of the first end portion.

17. The right-angle elbow assembly according to claim 1, wherein the right-angle elbow assembly is configured as a TE11 mode right-angle elbow assembly or a hollow structure.

18. The right-angle elbow assembly according to claim 1, wherein a longitudinal axis of the first end portion is perpendicular to a longitudinal axis of the second end portion.

19. A signal transmitter, comprising:
an antenna;
a right-angle elbow assembly coupled to the antenna, the right angle elbow assembly comprising:
a first end portion and a second end portion;
a connect portion extending between the first end portion and the second end portion; and
a ridge portion positioned in the connect portion and above a transition surface of the connect portion.

20. A signal receiver, comprising:
an antenna; and
a right-angle elbow assembly coupled to the antenna, the right angle elbow assembly comprising:
a first end portion and a second end portion;
a connect portion extending between the first end portion and the second end portion; and
a ridge portion positioned in the connect portion and above a transition surface of the connect portion.
